(19) United States
(12) Patent Application Publication
(10) Pub. No.: US 2022/0245045 A1
(43) Pub. Date: Aug. 4, 2022

(54) PREDICTION METHOD, PREDICTION APPARATUS, AND RECORDING MEDIUM

(71) Applicant: NEC Corporation, Minato-ku, Tokyo (JP)

(72) Inventor: Yasuhiro AJIRO, Tokyo (JP)

(73) Assignee: NEC Corporation, Minato-ku, Tokyo (JP)

(21) Appl. No.: 17/622,929

(22) PCT Filed: Jul. 4, 2019
(86) PCT No.: PCT/JP2019/026645

§ 371 Date: Dec. 27, 2021

(51) Int. Cl. G06F 11/30

(52) U.S. Cl. CPC G06F 11/3075

(57) ABSTRACT

A prediction method executed by a prediction apparatus includes searching for past time-series data similar to time-series data of search target and, based on a result of the searching and information corresponding to an event in past, calculating prediction information for predicting occurrence of the event.

### TECHNICAL FIELD

The present invention relates to a prediction method, a prediction apparatus, and a recording medium.

### BACKGROUND ART

A sign of fault or failure may be detected based on the result of monitoring a monitoring target.

One of the techniques used when detecting such a sign of failure is described in, for example, Patent Document 1. Patent Document 1 describes a monitoring apparatus that includes a means for storing time-series data, a first metadata conversion means, a second metadata conversion means, and a matching and sign detecting means. According to Patent Document 1, when the stored time-series data meets a selection condition, the first metadata conversion means performs predetermined processing and stores the time-series data into a past metadata storing means. Moreover, when time-series data representing real-time performance from a monitoring target system meets another selection condition set separately from the selection condition used by the first metadata conversion means, the second metadata conversion means generates real-time metadata. Then, the matching and sign predicting means matches the real-time metadata against the metadata stored in the metadata storing means, and detects and outputs a future change.

Patent Document 1: Japanese Unexamined Patent Application Publication No. JP-A 2009-289221

In the technique described in Patent Document 1, only time-series data that meets the selection condition is stored in the metadata storing means and becomes the target of matching by the matching and sign detecting means. Therefore, it is required to establish rules for candidates for the sign in advance. As a result, there has been a problem that when the establishment of rules is impossible or insufficient, it is difficult to output prediction information for predicting an anomaly such as a failure.

### SUMMARY

Accordingly, an object of the present invention is to provide a prediction method, a prediction apparatus, and a recording medium that solve the problem of difficulty in outputting prediction information for predicting an anomaly such as a failure without establishing a rule in advance.

In order to achieve the object, a prediction method according to an aspect of the present invention is executed by a prediction apparatus and includes searching for past time-series data similar to time-series data of search target and, based on a result of the searching and information corresponding to an event in past, calculating prediction information for predicting occurrence of the event.

Further, a prediction apparatus according to another aspect of the present invention includes: a search unit configured to search for past time-series data similar to time-series data of search targe; and a calculating unit configured to, based on a result searched by the search unit and information corresponding to an event in past, calculate prediction information for predicting occurrence of the event.

Further, a recording medium according to another aspect of the present invention is a non-transitory computer-readable recording medium having a program recorded thereon. The program includes instructions for causing a prediction apparatus to realize: a search unit configured to search for past time-series data similar to time-series data of search targe; and a calculating unit configured to, based on a result searched by the search unit and information corresponding to an event in past, calculate prediction information for predicting occurrence of the event.

With the configurations as described above, the present invention can provide a prediction method, a prediction apparatus, and a recording medium that solve the problem of difficulty in outputting prediction information for predicting an anomaly such as a failure without establishing a rule in advance.

### BRIEF DESCRIPTION OF DRAWINGS

FIG. 1 is a view showing an example of a configuration of an entire system according to a first example embodiment of the present invention;

FIG. 2 is a block diagram showing an example of a configuration of a prediction apparatus shown in FIG. 1;

FIG. 3 is a view showing an example of operation information shown in FIG. 2;

FIG. 4 is a view showing an example of anomaly-related information shown in FIG. 2;

FIG. 5 is a view showing an example of a search process;

FIG. 6 is a view showing an example of ranking information;

FIG. 7 is a view showing an example of statistical information;

FIG. 8 is a flowchart showing an example of an operation of the prediction apparatus;

FIG. 9 is a block diagram showing an example of another configuration of the prediction apparatus; and

FIG. 10 is a block diagram showing an example of a configuration of a prediction apparatus according to a second example embodiment of the present invention.

### EXAMPLE EMBODIMENTS

### First Example Embodiment

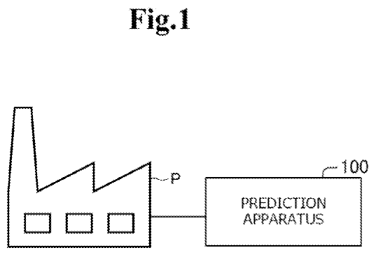

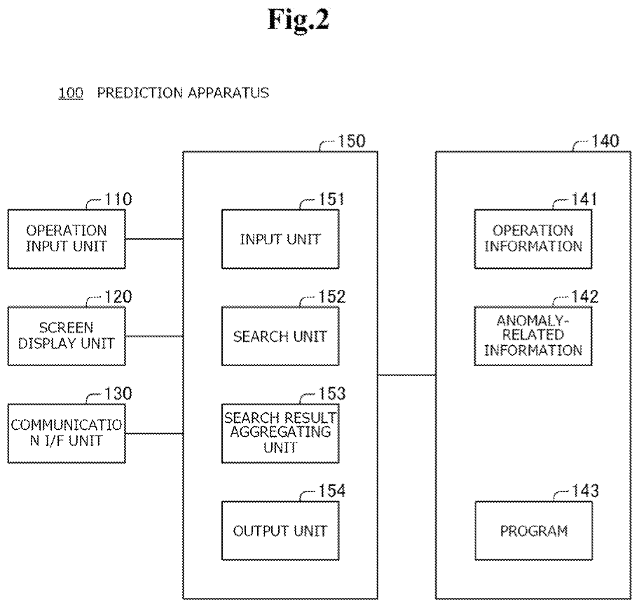

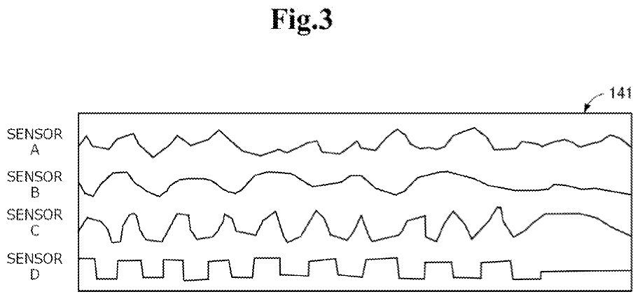

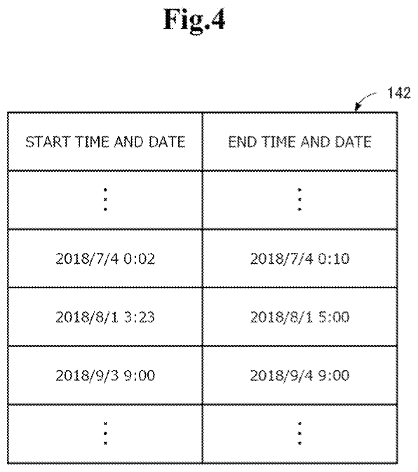

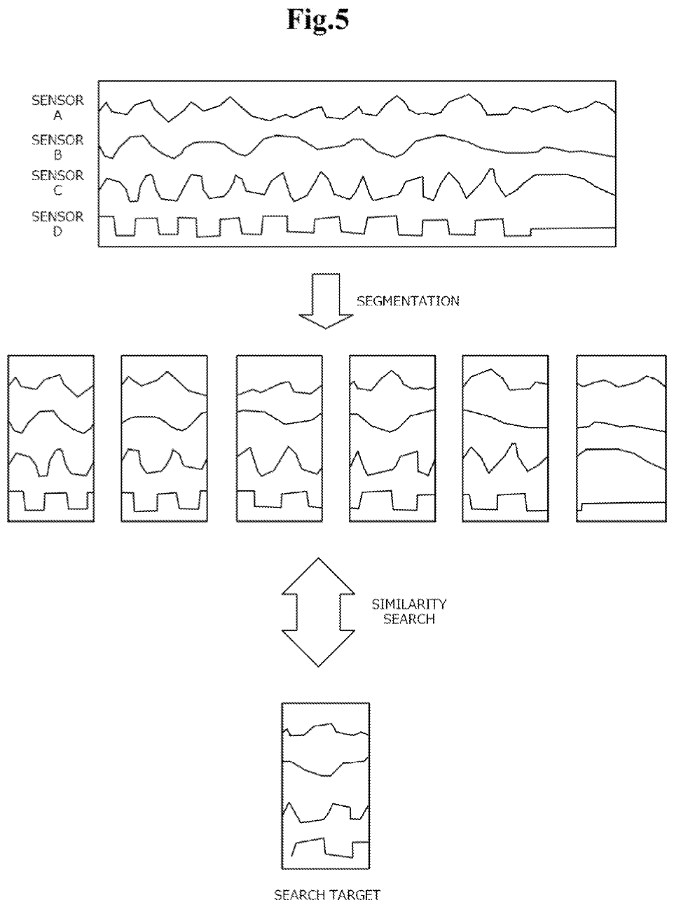

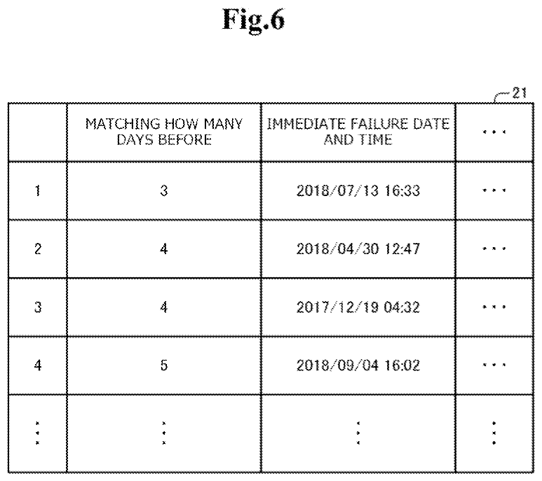

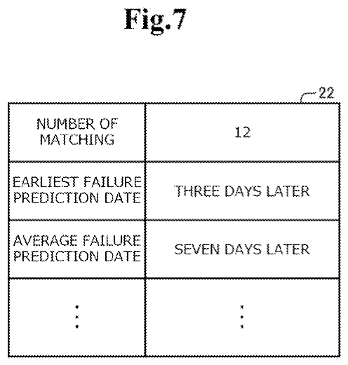

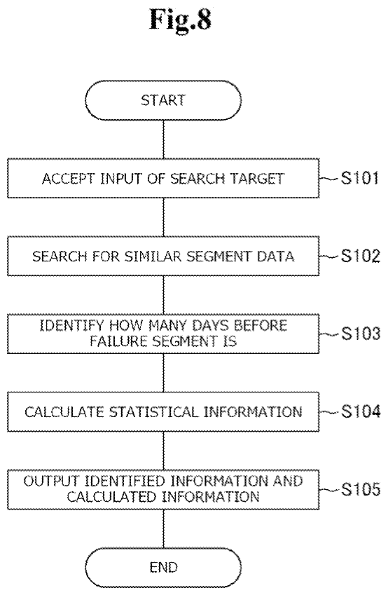

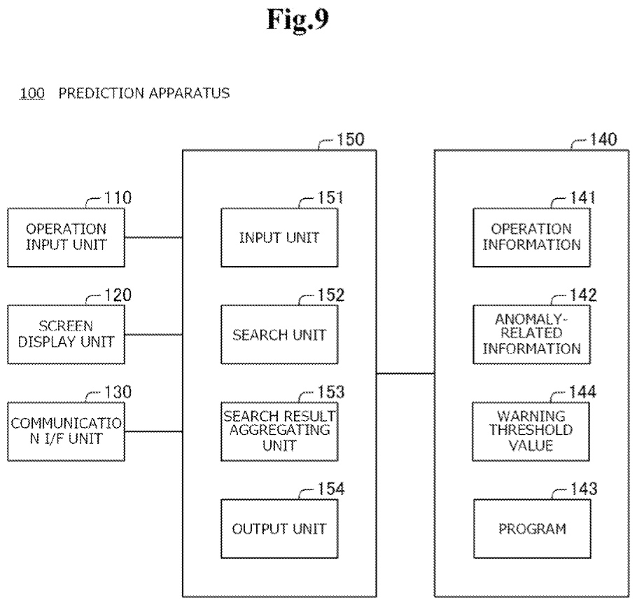

A first example embodiment of the present invention will be described with reference to FIGS. 1 to 9. FIG. 1 is a view showing an example of a configuration of an entire system. FIG. 2 is a block diagram showing an example of a configuration of a prediction apparatus 100. FIG. 3 is a view showing an example of operation information 141. FIG. 4 is a view showing an example of anomaly-related information 142. FIG. 5 is a view showing an example of a search process. FIG. 6 is a view showing an example of ranking information 21. FIG. 7 is a view showing an example of statistical information 22. FIG. 8 is a flowchart showing an example of an operation of the prediction apparatus 100. FIG. 9 is a block diagram showing an example of another configuration of the prediction apparatus 100.

In the first example embodiment of the present invention, the prediction apparatus 100 that outputs prediction information for predicting anomalies such as a failure and a fault of a monitoring target P based on time-series data will be described. As will be mentioned later, the prediction apparatus 100 described in this example embodiment searches for data similar to segment data to be a prediction target from among segment data obtained by segmenting time-series data stored in a storing unit 140. Moreover, the prediction apparatus 100 identifies how many days before a failure the searched data is, based on information indicating the time when an anomaly occurred in the monitoring target P. Then, the prediction apparatus 100 outputs the identified information, information based on the identified information, and so on, as prediction information.

As mentioned above, in this example embodiment, the prediction apparatus 100 that outputs prediction information for predicting an anomaly such as a failure will be described. However, the present invention can also be applied to an apparatus other than the apparatus that predicts an anomaly. For example, the prediction apparatus 100 can be configured to output prediction information for predicting the occurrence or nonoccurrence of any event other than an anomaly, and so on.

FIG. 1 shows an example of a configuration of an entire system to which the present invention is applied. Referring to FIG. 1, the prediction apparatus 100 according to the present invention is connected to the monitoring target P via a network or the like. The prediction apparatus 100 acquires various measurement values measured by various sensors installed in the monitoring target P from the monitoring target P via the network or the like.

The monitoring target P is, for example, a plant such as a manufacture factory or a processing facility. The monitoring target P may be a target other than those illustrated above, such as an information processing system, a retail store such as a convenience store, or a general house. Moreover, the various measurement values are, for example, the temperature, pressure, flow rate, power consumption value, supply amount and remaining amount of raw material, and so on, in the plant. As with the monitoring target P, the various measurement values may be values other than those illustrated above. For example, in a case where the monitoring target P is an information processing system, the various measurement values may be the CPU (Central Processing Unit) usage rate, memory usage rate, disk access frequency, number of input/output packets, power consumption value and so on of each of the information processing apparatuses configuring the information processing system. Moreover, for example, in a case where the monitoring target P is a retail store, a general house or the like, the various measurement values may be values acquired by sensors that monitor the states such as the temperatures of cooling equipment, air conditioning equipment, and various home appliances.

FIG. 2 shows an example of a configuration of the prediction apparatus 100. Referring to FIG. 2, the prediction apparatus 100 includes, as major components, an operation input unit 110, a screen display unit 120, a communication I/F unit 130, a storing unit 140, and an arithmetic processing unit 150, for example.

The operation input unit 110 is composed of operation input devices such as a keyboard and a mouse. The operation input unit 110 detects an operation by a user operating the prediction apparatus 100 and outputs to the arithmetic processing unit 150.

The screen display unit 120 is composed of a screen display device such as an LCD (Liquid Crystal Display). The screen display unit 120 displays ranking information 21, statistical information 22 or the like to be described later in response to an instruction from the arithmetic processing unit 150.

The communication I/F unit 130 is composed of a data communication circuit. The communication I/F unit 130 has a function of performing data communication with various devices connected via a communication line. For example, the prediction apparatus 100 acquires various measurement values or the like from the monitoring target P via the communication I/F unit 130.

The storing unit 140 is a storage device such as a hard disk or a memory. The storing unit 140 stores therein processing information and a program 143 that are necessary for various processing in the arithmetic processing unit 150. The program 143 is loaded to and executed by the arithmetic processing unit 150 and thereby realizes various processing units. The program 143 is previously loaded from an external device or a recording medium via a data input/output function such as the communication I/F unit 130 and stored into the storing unit 140. Major information stored in the storing unit 140 are, for example, operation information 141 and anomaly-related information 142.

The operation information 141 includes time-series data formed by various sensors installed in the monitoring target P measuring measurement values at predetermined time intervals. For example, when the prediction apparatus 100 acquires time-series data from the monitoring target P, the prediction apparatus 100 stores the acquired time-series data as the operation information 141 into the storing unit 140. The prediction apparatus 100 may be configured to acquire various measurement values from the monitoring target P regularly at predetermined time intervals and store into the storing unit 140 as necessary.

FIG. 3 shows an example of the operation information 141. For example, in the example shown in FIG. 3, the operation information 141 includes time-series data of measurement values acquired by four types of sensors of a sensor A, a sensor B, a sensor C, and a sensor D, respectively.

Herein, FIG. 3 shows an example of the operation information 141. The operation information 141 is not limited to that illustrated in FIG. 3. For example, the operation information 141 may include time-series data of a type other than the four types. Besides, in this example embodiment, it is assumed that the operation information 141 includes data at a time when an anomaly occurred in the monitoring target P.

The anomaly-related information 142 is information corresponding to a past anomaly (event) having occurred in the monitoring target P. The anomaly-related information 142 includes, for example, information (anomaly time information) indicating the time when an anomaly occurred in the monitoring target P. For example, when the prediction apparatus 100 acquires the anomaly time information from an external device such as the monitoring target P, the prediction apparatus 100 stores the acquired anomaly time information as the anomaly-related information 142 into the storing unit 140.

FIG. 4 shows an example of the anomaly-related information 142. Referring to FIG. 4, in the anomaly-related information 142, for example, “start time and date” indicating the time and date when an anomaly started and “end time and date” indicating the time and date when the anomaly ended are associated with each other. For example, in the second row of FIG. 4, “start time and date 0:02 on Jul. 4, 2018” and “end time and date 0:10 on Jul. 4, 2018” are associated with each other.

Herein, FIG. 4 shows an example of the anomaly-related information 142. The anomaly-related information 142 is not limited to that illustrated in FIG. 4. For example, the anomaly-related information 142 may include information indicating the content, type or the like of an anomaly such as a failure. Moreover, the anomaly-related information 142 may include information on an anomaly occurrence location indicating a place where the anomaly occurred, the name of a device or a component where the anomaly occurred, or the like, handling information indicating how the anomaly was handled, and so on. By including information indicating the content, type or the like of an anomaly in the anomaly-related information 142, it becomes possible to generate the ranking information 21 and the statistical information 22 to be described later for each content or type of anomaly when generating the ranking information 21 and the statistical information 22. Moreover, by including information on an anomaly occurrence location, handling information and so on in the anomaly-related information 142, it becomes possible to include the information on anomaly occurrence location, the handling information and so on into the ranking information 21 to be described later and so on. By thus including the information on anomaly occurrence location, the handling information and so on in the prediction information, it becomes possible to prepare for handling and prevent an anomaly.

The arithmetic processing unit 150 has a microprocessor such as an MPU and a peripheral circuit thereof. The arithmetic processing unit 150 loads the program 143 from the storing unit 140 and executes the program 143, thereby making the hardware and the program 143 cooperate and realizing various processing units. Major processing units realized by the arithmetic processing unit 15 are, for example, an input unit 151, a search unit 152, a search result aggregating unit 153, and an output unit 154.

The input unit 151 accepts input of various information from the monitoring target P, an external device, or the like.

For example, the input unit 151 accepts input of time-series data and anomaly time information from the monitoring target P, an external device, or the like. For example, when the input unit 151 accepts input of time-series data, the input unit 151 stores the accepted time-series data as the operation information 141 into the storing unit 140. Moreover, when the input unit 151 accepts input of anomaly time information, the input unit 151 stores the accepted anomaly time information as the anomaly-related information 142 into the storing unit 140.

Further, the input unit 151 accepts input of segment data to be a prediction target. Segment data to be a prediction target may be part of the abovementioned time-series data.

The search unit 152 searches for a segment obtained by segmenting time-series data shown by the operation information 141, using segment data to be a prediction target as a key. For example, the search unit 152 searches for data similar to segment data to be a prediction target from among segment data obtained by segmenting time-series data shown by the operation information 141.

The search by the search unit 152 is performed by calculating the feature value of a segment, for example. FIG. 5 is a view for describing an example of a search process by the search unit 152 when performing search with a feature value. Referring to FIG. 5, for example, the search unit 152 calculates the feature value of a segment to be a prediction target. Moreover, the search unit 152 segments time-series data shown by the operation information 141 into a plurality of segments, and calculates the feature values of the respective segments obtained by the segmentation. At this time, the search unit 152 may segment time-series data into a plurality of segments so that the period of one segment does not overlap with the periods of the other segments, or may segment time-series data into a plurality of segments so that the period of one segment overlaps with the period of another segment. Then, the search unit 152 searches for a segment similar to the segment to be prediction target by calculating the distance between the feature value of the segment to be prediction target and the feature value of each of the segments obtained by the segmentation. To be specific, for example, the search unit 152 searches for a segment obtained by the segmentation whose distance from the feature value of the segment to be prediction target is equal to or less than a predetermined threshold value, as a similar segment.

For example, as described above, the search unit 152 searches for a segment similar to a search target segment based on the feature values of the segments. In this embodiment, a method for calculating a feature value is not specifically limited. The search unit 152 can be configured to calculate the feature value of a segment by using a known method. Moreover, in this example embodiment, a method for calculating the distance between the feature values is not specifically limited.

The search result aggregating unit 153 associates a segment searched by the search unit 152 with the anomaly-related information 142. Then, the search result aggregating unit 153 aggregates the result of the association. With this, the search result aggregating unit 153 generates various prediction information such as the ranking information 21 and the statistical information 22, for example, based on the result of the search by the search unit 152.

For example, the search result aggregating unit 153 refers to the anomaly-related information 142 to identify how past the time to which a segment searched by the search unit 152 belongs is from the time when an anomaly occurring after the abovementioned time occurred, and thereby performs the abovementioned association. For example, it is assumed that anomaly time information indicating that an anomaly occurs from 0:02 on Jul. 4, 2018 to 0:10 on Jul. 4, 2018 is stored in the anomaly-related information 142. In such a case, in a case where the time to which a segment searched by the search unit 152 belongs is 0:01 on Jul. 2, 2018, the search result aggregating unit 153 identifies that the segment is two days before an anomaly occurs. That is to say, the search result aggregating unit 153 identifies that a segment targeting one minute at 0:01 on Jul. 2, 2018 is data two days before the time when an anomaly occurs. In this manner, the search result aggregating unit 153 identifies how past (how many days before) data of a segment searched by the search unit 152 is from the time when an anomaly occurred, based on the anomaly-related information 142. The search result aggregating unit 153 may be configured to identify how many hours before the occurrence of an anomaly data of a segment searched by the search unit 152 is based on the abnormality-related information 142.

Further, the search result aggregating unit 153 performs a process of sorting information for identifying a segment searched by the search unit 152 in accordance with the abovementioned process. For example, the search result aggregating unit 153 performs a process of sorting in ascending order based on information indicating how past it is from the time when an anomaly occurs. With this, the search result aggregating unit 153 generates the ranking information 21 as shown in FIG. 6.

The ranking information 21 may include, for example, as shown in FIG. 6, a column of “matching how many days before” indicating how many days before the failure the searched segment data is, or a column of “time and date of immediate failure” indicating the time and date of the earliest occurrence of an anomaly after the time to which the searched segment belongs, as information for identifying the searched segment. The ranking information 21 may include information other than those illustrated above, such as information on an anomaly occurrence location and handling information.

Further, the search result aggregating unit 153 can calculate, based on the search result by the search unit 152 and the information specified in the abovementioned processing, the statistical information 22 corresponding to the search result and so on. FIG. 7 shows an example of the statistical information 22. Referring to FIG. 7, the search result aggregating unit 153 calculates, for example, “number of matching” indicating the number of segments similar to a segment to be a prediction target, “earliest failure prediction date” indicating the smallest number of days in the identified column of “matching how many days before”, “average failure prediction date” indicating the average value in the identified column of “matching how many days before”, and so on, as the statistical information 22.

For example, the search result aggregating unit 153 calculates “number of matching” by counting the number of segments similar to a segment to be a prediction target. Moreover, the search result aggregating unit 153 sets the highest value (that is, the smallest value) of the values of the column of “matching how many days before” in the ranking information 21 as “earliest failure prediction date”. For example, in the example of FIG. 6, numbers “3”, “4”, “4” “5”, . . . are shown in ascending order in the column of “matching how many days before”. Therefore, the search result aggregating unit 153 sets “3”, which is the smallest value of the values shown in ascending order, as “earliest failure prediction date”. Moreover, the search result aggregating unit 153 calculates “average failure prediction date” by calculating the average value of the values in the column of “matching how many days before” in the ranking information 21. The search result aggregating unit 153 calculates the statistical information 22 such as “number of matching”, “earliest failure prediction date”, and “average failure prediction date” through the processes as described above, for example.

The search result aggregating unit 153 may be configured to generate the ranking information 21 for each content or type of anomaly such as failure. Moreover, the search result aggregating unit 153 may be configured to calculate the statistical information 22 for each content or type of anomaly such as failure.

Further, the search result aggregating unit 153 may be configured to generate and calculate only part of the ranking information 21 and the statistical information 22 illustrated above. Moreover, the search result aggregating unit 153 may be configured to generate and calculate information other than those illustrated above.

The output unit 154 outputs the information specified and calculated by the search result aggregating unit 153.

For example, the output unit 154 displays the ranking information 21 and the statistical information 22 on the screen display unit 120. Alternatively, the output unit 154 transmits the ranking information 21 and the statistical information 22 to an external device via the communication I/F unit 130.

As described above, the output unit 154 performs output control such as display on the screen display unit 120 and transmission to an external device. The output unit 154 may be configured to perform output other than those illustrated above, such as output using voice.

The above is an example of the configuration of the prediction apparatus 100. Subsequently, an example of an operation of the prediction apparatus 100 will be described with reference to FIG. 8.

Referring to FIG. 8, the input unit 151 accepts input of segment data to be a prediction target (step S101).

The search unit 152 searches for data similar to the segment data to be the prediction target from among segment data obtained by segmenting time-series data shown by the operation information 141 using the segment data to be the prediction target as a key (step S102).

The search result aggregating unit 153 identifies how many days before the occurrence of an anomaly the segment data searched by the search unit 152 is, based on the anomaly-related information 142 (step S103). Then, the search result aggregating unit 153 generates the ranking information 21 by performing a process of sorting information for identifying the segment data searched by the search unit 152 in accordance with the result of the identification. Moreover, the search result aggregating unit 153 calculates the statistical information 22 based on the identified information and the result of the search by the search unit 152 (step S104).

The output unit 154 outputs the information identified in the process of step S103, the statistical information 22 calculated in the process of step S104, and so on (step S105).

The above is an example of the operation of the prediction apparatus 100.

As shown above, the prediction apparatus 100 includes the search unit 152, the search result aggregating unit 153, and the output unit 154. With such a configuration, the search unit 152 can search for data similar to segment data to be a prediction target. Moreover, the search result aggregating unit 153 can generate the ranking information 21 and calculate the statistical information 22 based on the result of detection by the search unit 152. As a result, the output unit 154 can output the ranking information 21, the statistical information 22, and so on. That is to say, with the above configuration, the prediction apparatus 100 can output the ranking information 21 and the statistical information 22 that are prediction information for predicting an anomaly such as a failure without establishing a rule in advance.

However, the configuration of the prediction apparatus 100 is not limited to that described in this example embodiment.

For example, FIGS. 2 and 9 illustrate the prediction apparatus 100 composed of one information processing apparatus. However, the prediction apparatus 100 may be composed of a plurality of information processing apparatuses connected via a network.

Further, the prediction apparatus 100 can be configured to output warning information such as an alert when a predetermined condition is satisfied, for example. FIG. 9 shows an example of a configuration of the prediction apparatus 100 that outputs warning information. Referring to FIG. 9, in the case of outputting warning information, the prediction apparatus 100 stores a warning threshold value 144 in the storing unit 140, for example. The warning threshold value 144 is information indicating a predetermined period such as one week before a failure. In a case where the warning threshold value 144 is stored in the storing unit 140, the search result aggregating unit 153 checks whether or not the largest value (may be the average value, or the like) of the values in the column of “matching how many days before” in the ranking information 21 is equal to or less than a value indicated by the warning threshold value 144, for example. Then, in a case where the largest value (may be the average value, or the like) of the values in the column of “matching how many days before” is equal to or less than the value indicated by the warning threshold value 144, the search result aggregating unit 153 outputs warning information to the screen display unit 120 or an external device. For example, as described above, the prediction apparatus 100 can be configured to output warning information in a case where segment data to be a prediction target is similar to data at a certain point within a period indicated by the warning threshold value 144 from the day of the occurrence of an anomaly and does not match data at the normal time excluding the above.

Further, the prediction apparatus 100 may be configured to set only one segment as a search target, or may be configured to set a plurality of segments as search targets.

### Second Example Embodiment

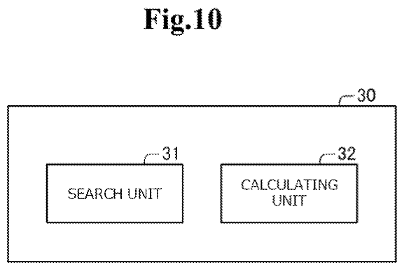

Next, a second example embodiment of the present invention will be described with reference to FIG. 10. In the second example embodiment, the overview of a configuration of a prediction apparatus 30 will be described.

FIG. 10 shows an example of a configuration of the prediction apparatus 30. Referring to FIG. 10, the prediction apparatus 30 includes a search unit 31 and a calculating unit 32.

The search unit 31 searches for past time-series data similar to search target time-series data.

The calculating unit 32 calculates prediction information for predicting the occurrence of an event based on the result of search by the search unit 31 and information associated with a past event.

As shown above, the prediction apparatus 30 includes the search unit 31 and the calculating unit 32. With such a configuration, the calculating unit 32 can calculate prediction information for predicting the occurrence of an event based on the result of the search by the search unit 31 and the information associated with the past event. With this, the prediction information calculated by the calculating unit 32 can be output. That is to say, with the above configuration, the prediction apparatus 30 can output the prediction information for predicting an anomaly such as a failure without establishing a rule in advance.

Further, the above prediction apparatus 30 can be realized by installation of a predetermined program in the prediction apparatus 30. To be specific, a program according to another aspect of the present invention is a program for causing the prediction apparatus 30 to realize: the search unit 31 configured to search for past time-series data similar to search target time-series data; and the calculating unit 32 configured to calculate prediction information for predicting the occurrence of an event based on the result of the search by the search unit 31 and information associated with a past event.

Further, a prediction method executed by the above prediction apparatus 30 is a method by which the prediction apparatus 30 searches for past time-series data similar to search target time-series data and calculates prediction information for predicting the occurrence of an event based on the search result and information associated with a past event.

Since the invention of the program or prediction method having the above configuration has the same action and effect as the prediction apparatus 30, it can achieve the abovementioned object of the present invention. Moreover, since a computer-readable recording medium on which the abovementioned program is recorded has the same action and effect as the prediction apparatus 30, it can achieve the abovementioned object of the present invention.

### SUPPLEMENTARY NOTES

The whole or part of the example embodiments disclosed above can be described as the following supplementary notes. Below, the overview of a prediction method and so on according to the present invention will be described. However, the present invention is not limited to the following configurations.

### (Supplementary Note 1)

A prediction method executed by a prediction apparatus, the prediction method comprising

searching for past time-series data similar to time-series data of search target and, based on a result of the searching and information corresponding to an event in past, calculating prediction information for predicting occurrence of the event.

### (Supplementary Note 2)

The prediction method according to Supplementary Note 1, comprising

calculating, as the prediction information, information indicating how past the past time-series data similar to the time-series data of search target is from a time when the event occurred, based on the result of the searching and the information corresponding to the event in past.

### (Supplementary Note 3)

The prediction method according to Supplementary Note 2, comprising

calculating the information indicating how past the past time-series data similar to the time-series data of search target is from the time when the event occurred, based on the result of the searching and the information corresponding to the event in past, and performing a process of sorting information for identifying the searched time-series data based on a result of the calculating.

### (Supplementary Note 4)

The prediction method according to Supplementary Note 2 or 3, comprising

calculating, as the prediction information, information indicating time and date when the event occurred earliest after a time to which the past time-series data similar to the time-series data of search target belongs, based on the result of the searching and the information corresponding to the event in past.

### (Supplementary Note 5)

The prediction method according to any one of Supplementary Notes 1 to 4, comprising

calculating, as the prediction information, statistical information corresponding to the result of the searching based on the result of the searching and the information corresponding to the event in past.

### (Supplementary Note 6)

The prediction method according to Supplementary Note 5, comprising

calculating information indicating how many days before the past time-series data similar to the time-series data of search target is from the time when the event occurred, based on the result of the searching and the information corresponding to the event in past, and calculating the statistical information based on a result of the calculating.

### (Supplementary Note 7)

The prediction method according to any one of Supplementary Notes 1 to 6, wherein

the information corresponding to the event in past is information indicating time when the event occurred.

### (Supplementary Note 8)

The prediction method according to any one of Supplementary Notes 1 to 7, comprising

searching for a similar segment from among segments obtained by segmenting the past time-series data, using the time-series data of search target as a key.

### (Supplementary Note 9)

The prediction method according to any one of Supplementary Notes 1 to 8, comprising

outputting the prediction information.

### (Supplementary Note 10)

A prediction apparatus comprising:

a search unit configured to search for past time-series data similar to time-series data of search targe; and

a calculating unit configured to, based on a result searched by the search unit and information corresponding to an event in past, calculate prediction information for predicting occurrence of the event.

### (Supplementary Note 11)

A non-transitory computer-readable recording medium having a program recorded thereon, the program comprising instructions for causing a prediction apparatus to realize:

a search unit configured to search for past time-series data similar to time-series data of search targe; and

a calculating unit configured to, based on a result searched by the search unit and information corresponding to an event in past, calculate prediction information for predicting occurrence of the event.

The program described in the example embodiments and supplementary notes is stored in a storage device or recorded on a computer-readable recording medium. For example, the recording medium is a portable medium such as a flexible disk, an optical disk, a magnetooptical disk, and a semiconductor memory.

Although the present invention has been descried above with reference to the example embodiments, the present invention is not limited to the above example embodiments. The configurations and details of the present invention can be changed in various manners that can be understood by one skilled in the art within the scope of the present invention.

### DESCRIPTION OF NUMERALS

100 prediction apparatus

110 operation input unit

120 screen display unit

130 communication I/F unit

140 storing unit

141 operation information

142 anomaly-related information

143 program

144 warning threshold value

150 arithmetic processing unit

151 input unit

152 search unit

153 search result aggregating unit

154 output unit

21 ranking information

22 statistical information

30 prediction apparatus

31 search unit

32 calculating unit

What is claimed is:

1. A prediction method executed by a prediction apparatus, the prediction method comprising
searching for past time-series data similar to time-series data of search target and, based on a result of the searching and information corresponding to an event in past, calculating prediction information for predicting occurrence of the event.

2. The prediction method according to claim 1, comprising
calculating, as the prediction information, information indicating how past the past time-series data similar to the time-series data of search target is from a time when the event occurred, based on the result of the searching and the information corresponding to the event in past.

3. The prediction method according to claim 2, comprising
calculating the information indicating how past the past time-series data similar to the time-series data of search target is from the time when the event occurred, based on the result of the searching and the information corresponding to the event in past, and performing a process of sorting information for identifying the searched time-series data based on a result of the calculating.

4. The prediction method according to claim 2, comprising
calculating, as the prediction information, information indicating time and date when the event occurred earliest after a time to which the past time-series data similar to the time-series data of search target belongs, based on the result of the searching and the information corresponding to the event in past.

5. The prediction method according to any onc of claims 1 to claim 1, comprising
calculating, as the prediction information, statistical information corresponding to the result of the searching based on the result of the searching and the information corresponding to the event in past.

6. The prediction method according to claim 5, comprising
calculating information indicating how many days before the past time-series data similar to the time-series data of search target is from the time when the event occurred, based on the result of the searching and the information corresponding to the event in past, and calculating the statistical information based on a result of the calculating.

7. The prediction method according to claim 1, wherein
the information corresponding to the event in past is information indicating time when the event occurred.

8. The prediction method according to claim 1, comprising
searching for a similar segment from among segments obtained by segmenting the past time-series data, using the time-series data of search target as a key.

9. The prediction method according to claim 1, comprising
outputting the prediction information.

10. A prediction apparatus comprising:
at least one memory configured to store instructions; and
at least one processor configured to execute instructions to:
search for past time-series data similar to time-series data of search target; and
based on a result searched by the search unit and information corresponding to an event in past, calculate prediction information for predicting occurrence of the event.

11. A non-transitory computer-readable recording medium having a program recorded thereon, the program comprising instructions for causing a prediction apparatus to realize:
a search unit configured to search for past time-series data similar to time-series data of search target; and
a calculating unit configured to, based on a result searched by the search unit and information corresponding to an event in past, calculate prediction information for predicting occurrence of the event.
